(19) United States
(12) Patent Application Publication
(10) Pub. No.: US 2026/0287045 A1
(43) Pub. Date: Sep. 24, 2026

(54) DECELERATOR

(71) Applicant: HYUNDAI MOBIS CO., LTD., Seoul (KR)

(72) Inventor: Chang Wook SON, Yongin-si (KR)

(73) Assignee: HYUNDAI MOBIS CO., LTD., Seoul (KR)

(21) Appl. No.: 19/321,398

(22) Filed: Sep. 8, 2025

(30) Foreign Application Priority Data
Mar. 19, 2025 (KR) 10-2025-0035582

(51) Int. Cl. F16H 19/08; B62D 5/04

(52) U.S. Cl. CPC F16H 19/08; B62D 5/0421; B62D 5/043; B62D 5/0454

(57) ABSTRACT

Disclosed is a decelerator, including a driving unit configured to provide power, a deceleration unit configured to decelerate power input from the driving unit and transmit the resulting power, an output shaft concentrically connected to the deceleration unit and configured to output power transmitted from the deceleration unit, and an eccentric connection unit configured to eccentrically connect the driving unit and the deceleration unit to cause deceleration using eccentric power and block power input in a reverse direction through the output shaft.

### CROSS-REFERENCE TO RELATED APPLICATIONS

The present application claims priority and the benefit of Korean Patent Application No. 10-2025-0035582, filed on Mar. 19, 2025 in the Korean Intellectual Property Office, the entire disclosure of which is incorporated herein by reference.

### TECHNICAL FIELD

Exemplary embodiments of the present disclosure relate to a decelerator capable of decelerating power input in a forward direction according to a predetermined reduction ratio and transmitting the resulting power, and blocking power input in a reverse direction, thereby enabling application in a vehicle steering system.

### BACKGROUND

Recent vehicle steering systems are equipped with hydraulic devices, motors, and reducers, allowing the steering of the vehicle's drive wheels based on the driving conditions of the vehicle.

As described above, the steering systems that control the steering of the vehicle using a motor without mechanical connection are applied to systems such as four-wheel independent steering systems and steer-by-wire (SBW) systems.

Such motor-controlled steering systems may also be applied to rear wheel steering (RWS) systems of the vehicle.

In general, the rear wheel steering system operates to reduce the turning radius when the vehicle is at low speeds and enhance driving stability when the vehicle is at high speeds.

A representative example of a conventional rear wheel steering system using a motor is the use of a lead screw directly connected to a hollow motor as a reducer in consideration of vehicle mountability.

Such a reducer structure includes a nut directly connected to a rotor shaft of the hollow motor and a lead screw bar that converts the rotation of the nut into a linear motion.

Due to the low efficiency of the lead screw bar, which inherently relies on surface contact, the output of the hollow motor applied to the conventional structure increases, resulting in increased motor size and costs.

In addition, reverse input transmitted through the lead screw bar is directly delivered to the motor through the nut, which degrades motor performance and causes issues with noise and vibration.

The related art of the present disclosure is disclosed in Korean Patent Application Publication No. 10-2018-0130240 (published on Dec. 7, 2018 and entitled “REAR WHEEL STEERING”).

### SUMMARY

Exemplary embodiments of the present disclosure are directed to providing a decelerator capable of decelerating power input from a driving unit and transmitting the resulting power to an output shaft, blocking power input in a reverse direction through the output shaft to enable application in a vehicle steering system, and incorporating a cycloidal gear with a simple structure, which realizes both deceleration and reverse input blocking functions, into a deceleration unit to provide the reverse input blocking function without a separate blocking device.

A decelerator according to the present disclosure includes a driving unit configured to provide power, a deceleration unit configured to decelerate power input from the driving unit and transmit the resulting power, an output shaft concentrically connected to the deceleration unit and configured to output power transmitted from the deceleration unit, and an eccentric connection unit configured to eccentrically connect the driving unit and the deceleration unit to cause deceleration using eccentric power and block power input in a reverse direction through the output shaft.

The deceleration unit may include a ring gear having a plurality of first gear teeth on an inner wall, and a disk member disposed inside the ring gear, having an outer diameter smaller than an inner diameter of the ring gear, and having a plurality of second gear teeth. At least one second gear tooth among the plurality of second gear teeth may be engaged with at least one first gear tooth among the plurality of first gear teeth to allow power to be transmitted in a forward direction from the driving unit to the output shaft.

The output shaft may include a plate member on which the disk member is movably seated, and the disk member may be movably connected to the plate member by the eccentric connection unit.

The eccentric connection unit may include an eccentric block eccentrically connected to a drive shaft of the driving unit and rotatably inserted into the disk member, and a transmission shaft extending from the plate member to be inserted into a plurality of transmission holes formed in the disk member.

An inner diameter of the transmission hole may be formed larger than an outer diameter of the transmission shaft, and the disk member may be slidably seated on the plate member.

A clearance between the inner diameter of the transmission hole and the outer diameter of the transmission shaft may be formed to be equal to eccentricity of the eccentric block.

A plurality of transmission shafts may be provided, and the decelerator may further include a support configured to connect the plurality of transmission shafts.

The support may include a prevention hole configured to prevent interference between the drive shaft and the support.

In response to power input in the reverse direction to the output shaft, at least one second gear tooth among the plurality of second gear teeth may be blocked by at least one first gear tooth among the plurality of first gear teeth, such that the disk member may not rotate.

The decelerator may be installed in a vehicle rear wheel steering system.

The decelerator according to the present disclosure includes an eccentric connection unit that eccentrically transmits power input from the driving unit, such that the rotation radius of the disk member, rotated by the power input to the deceleration unit, becomes larger than the diameter of the disk member, allowing power to be transmitted to the deceleration unit. Since deceleration is performed by eccentric power transmitted to the deceleration unit incorporating a cycloidal gear mechanism, power input in the reverse direction through the output shaft, which is not eccentric, is blocked by the deceleration unit.

The eccentric connection unit of the decelerator according to the present disclosure includes a plurality of transmission shafts that extend from the output shaft and are movably connected to the disk member. Accordingly, as the disk member revolves and rotates relative to the first gear teeth of the ring gear, the transmission shafts move within the transmission holes of the disk member, thereby preventing deformation or damage to the transmission shafts and the output shaft caused by the eccentric power of the disk member.

The eccentric connection unit of the decelerator according to the present disclosure includes the plurality of transmission shafts that extend from the output shaft and are movably connected to the disk member. Accordingly, when power is input in the reverse direction through the output shaft, concentric (non-eccentric) power is transmitted to the disk member via the plurality of transmission shafts, which restricts the rotational motion of the disk member geared to the ring gear, thereby blocking power input in the reverse direction.

The decelerator according to the present disclosure is capable of decelerating and transmitting motor power via the deceleration unit that incorporates a cycloidal gear mechanism with a simple structure, without a separate blocking device, and blocking power input in the reverse direction through the output shaft, which allows omission of a blocking device for preventing reverse input that is installed in a vehicle steering system and contributes to reducing the time and cost required for steering system manufacturing and installation.

### BRIEF DESCRIPTION OF THE DRAWINGS

FIG. 1 is a perspective view of a steering system having a decelerator according to an embodiment of the present disclosure.

FIG. 2 is a perspective view illustrating a driving unit and a deceleration unit of a decelerator according to an embodiment of the present disclosure.

FIG. 3 is an exploded perspective view illustrating a driving unit and a deceleration unit of a decelerator according to an embodiment of the present disclosure.

FIG. 4 is a bottom-exploded perspective view illustrating a driving unit and a deceleration unit of a decelerator according to an embodiment of the present disclosure.

FIG. 5 is a perspective view illustrating a deceleration unit of a decelerator according to an embodiment of the present disclosure.

FIG. 6 is an exploded perspective view illustrating a deceleration unit and an eccentric connection unit of a decelerator according to an embodiment of the present disclosure.

FIG. 7 is a cross-sectional view illustrating a deceleration unit and an eccentric connection unit of a decelerator according to an embodiment of the present disclosure.

FIG. 8 is a plan view illustrating a deceleration unit of a decelerator according to an embodiment of the present disclosure.

FIG. 9 is a view illustrating a first rotational state of a disk member of a decelerator according to an embodiment of the present disclosure.

FIG. 10 is a view illustrating a second rotational state of a disk member of a decelerator according to an embodiment of the present disclosure.

FIG. 11 is a view illustrating a third rotational state of a disk member of a decelerator according to an embodiment of the present disclosure.

FIG. 12 is a view illustrating a fourth rotational state of a disk member of a decelerator according to an embodiment of the present disclosure.

### DETAILED DESCRIPTION

An embodiment of a decelerator according to the present disclosure will be described hereinafter with reference to the accompanying drawings.

In this process, the thickness of lines and the size of elements illustrated in the drawing may be exaggerated for clarity and convenience of description.

In addition, the terms used below are defined in consideration of the functions thereof in the present disclosure and may vary depending on the intention of a user or an operator or common practice.

Therefore, the definitions of such terms should be made based on the content set forth throughout the present specification.

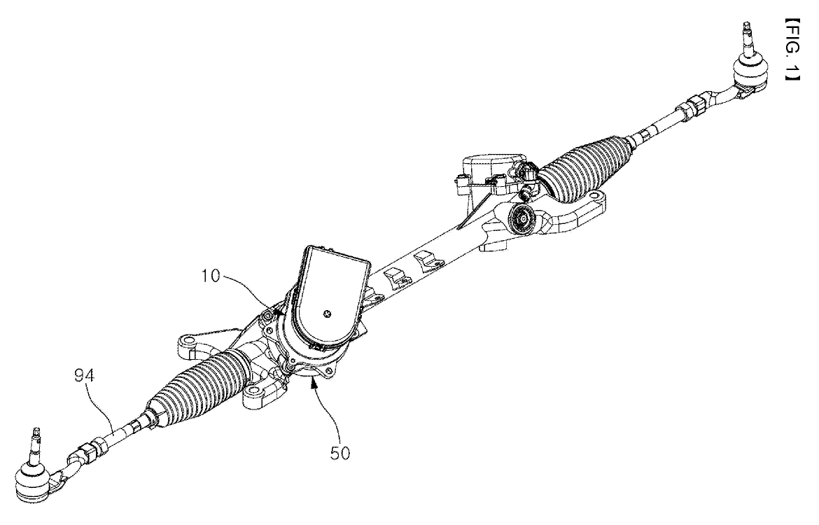

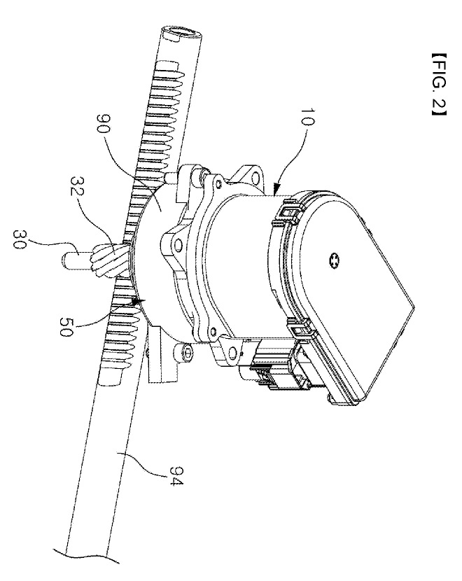

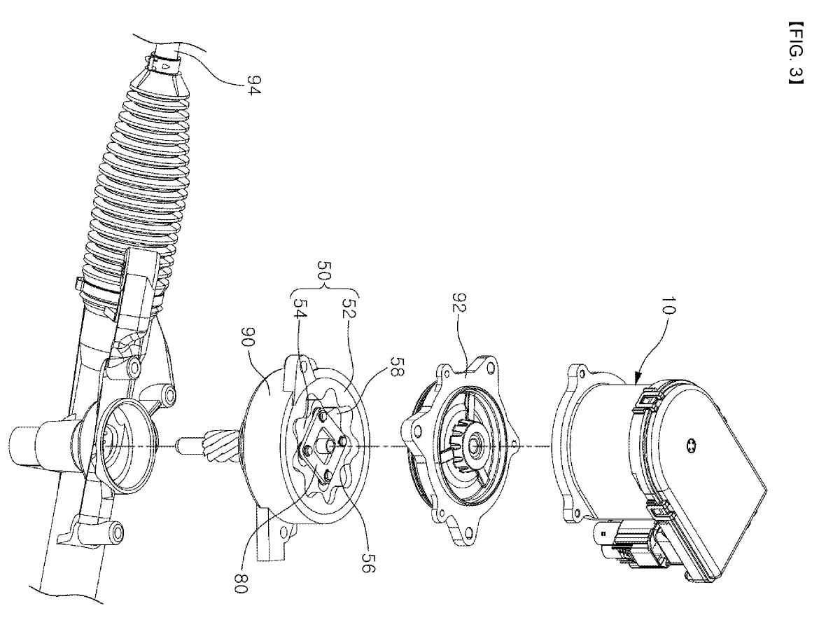

FIG. 1 is a perspective view of a steering system having a decelerator according to an embodiment of the present disclosure. FIG. 2 is a perspective view illustrating a driving unit and a deceleration unit of a decelerator according to an embodiment of the present disclosure. FIG. 3 is an exploded perspective view illustrating a driving unit and a deceleration unit of a decelerator according to an embodiment of the present disclosure.

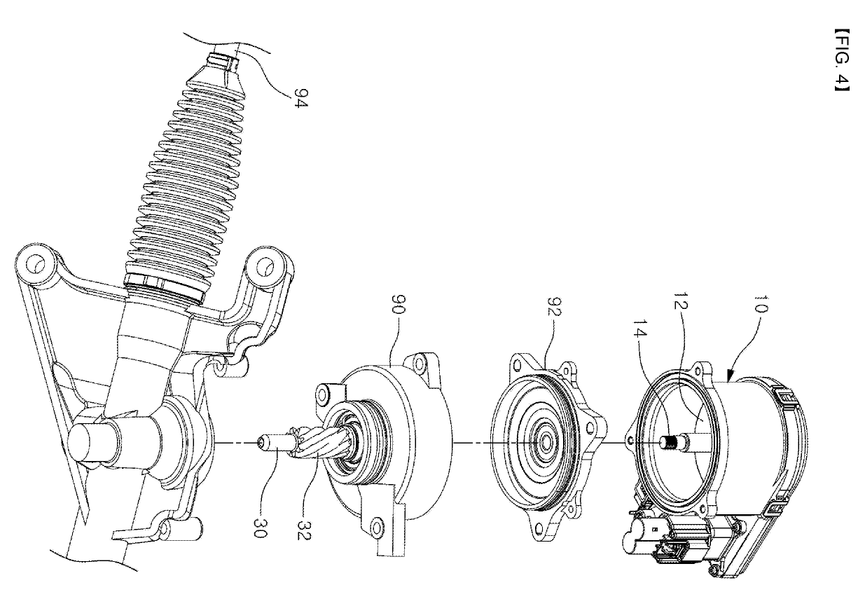

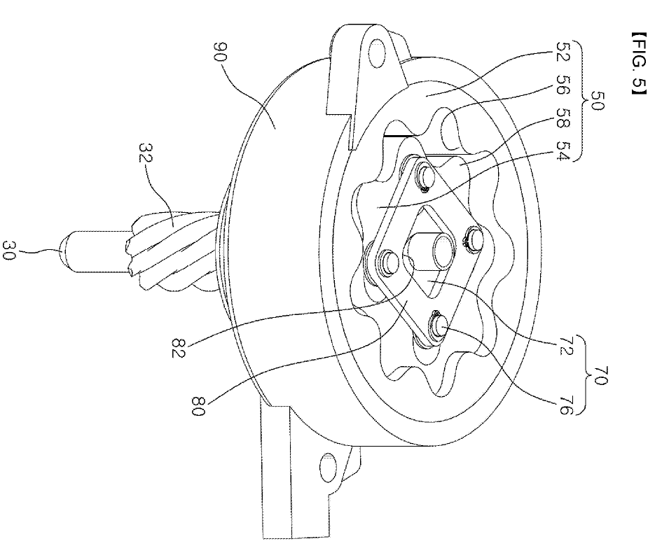

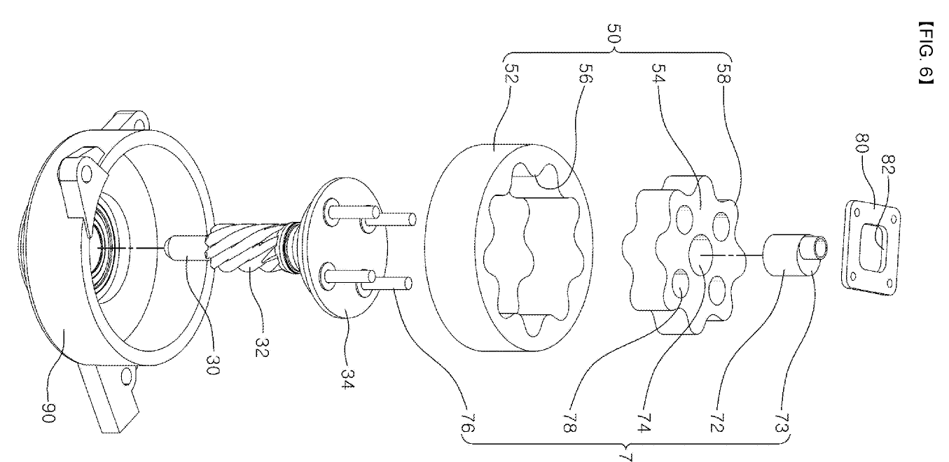

FIG. 4 is a bottom-exploded perspective view illustrating a driving unit and a deceleration unit of a decelerator according to an embodiment of the present disclosure. FIG. 5 is a perspective view illustrating a deceleration unit of a decelerator according to an embodiment of the present disclosure. FIG. 6 is an exploded perspective view illustrating a deceleration unit and an eccentric connection unit of a decelerator according to an embodiment of the present disclosure.

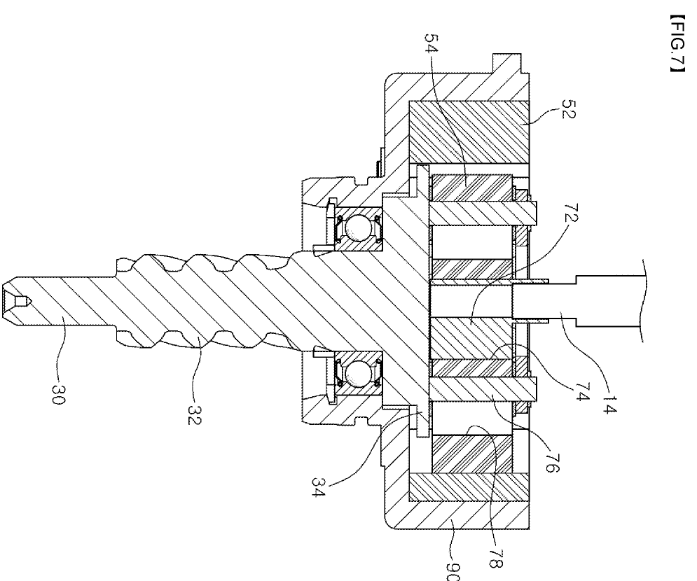

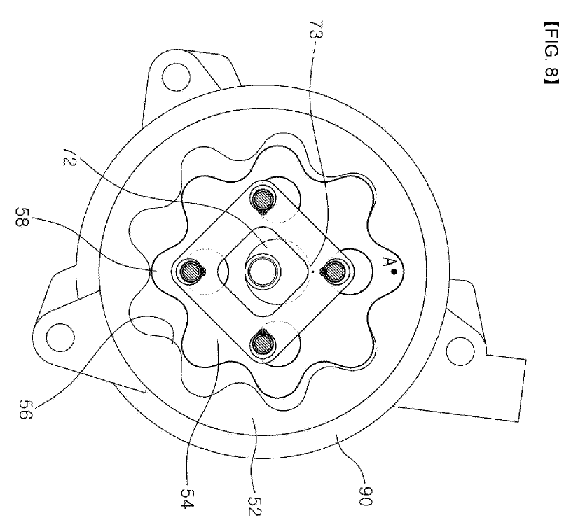

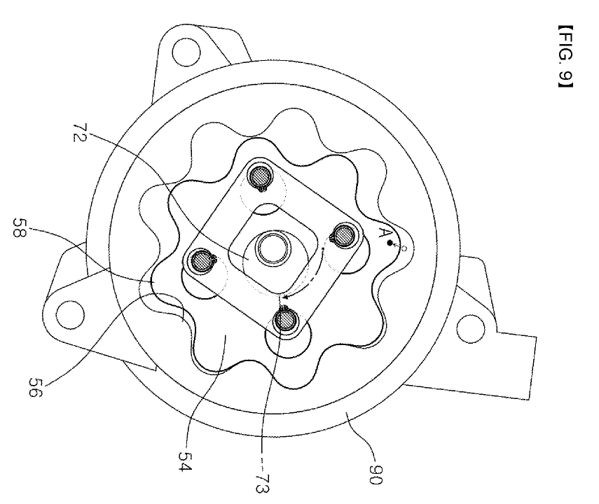

FIG. 7 is a cross-sectional view illustrating a deceleration unit and an eccentric connection unit of a decelerator according to an embodiment of the present disclosure. FIG. 8 is a plan view illustrating a deceleration unit of a decelerator according to an embodiment of the present disclosure. FIG. 9 is a view illustrating a first rotational state of a disk member of a decelerator according to an embodiment of the present disclosure.

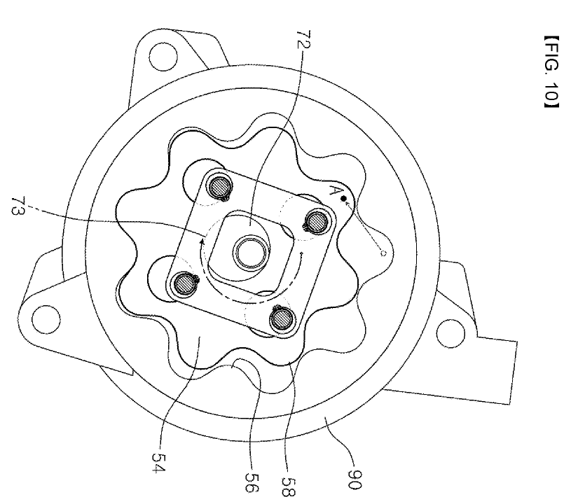

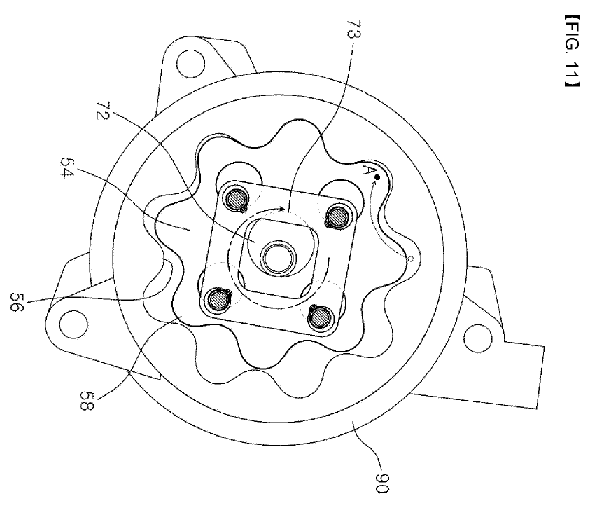

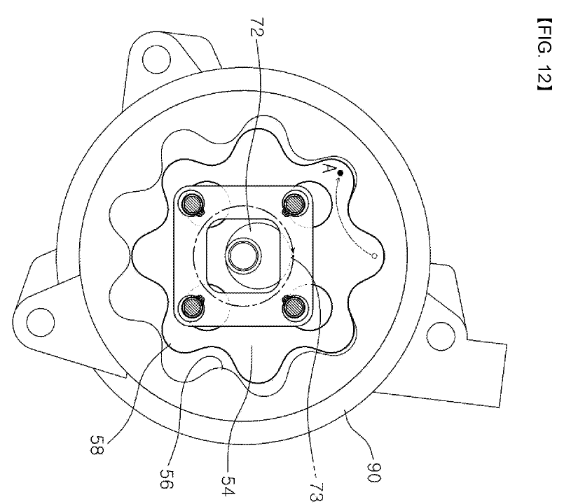

FIG. 10 is a view illustrating a second rotational state of a disk member of a decelerator according to an embodiment of the present disclosure. FIG. 11 is a view illustrating a third rotational state of a disk member of a decelerator according to an embodiment of the present disclosure. FIG. 12 is a view illustrating a fourth rotational state of a disk member of a decelerator according to an embodiment of the present disclosure.

Referring to FIGS. 1 to 12, a decelerator according to an embodiment of the present disclosure includes a driving unit 10 configured to provide power, a deceleration unit 50 configured to decelerate power input from the driving unit 10 and to transmit the resulting power, an output shaft 30 concentrically connected to the deceleration unit 50 and configured to output the power transmitted from the deceleration unit 50, and an eccentric connection unit 70 configured to eccentrically connect the driving unit 10 and the deceleration unit 50 to cause deceleration using eccentric power and to block power input in a reverse direction through the output shaft 30.

Accordingly, when power is output from a motor 12 that constitutes the driving unit 10, the power is transmitted to the deceleration unit 50 through a drive shaft 14, and the decelerated power by the operation of the deceleration unit 50 is supplied through the output shaft 30.

For example, in the present embodiment, power input to the deceleration unit 50 is transmitted as eccentric power, offset from the central axis, by the operation of the eccentric connection unit 70, and the eccentric power is transmitted to the concentrically connected output shaft 30, thereby achieving deceleration according to a predetermined ratio.

Since the deceleration unit 50 in the present embodiment is driven by eccentric power, when power is input in the reverse direction from the concentrically connected output shaft 30, the rotational motion of the deceleration unit 50 is blocked, thereby preventing the reverse-direction power from being transmitted to the motor 12.

The deceleration unit 50 in the present embodiment includes a ring gear 52 having a plurality of first gear teeth 56 on the inner wall, and a disk member 54 having a plurality of second gear teeth 58.

The ring gear 52 is inserted into and fixed inside a case 90. The disk member 54 is disposed inside the ring gear 52. The disk member 54 may have an outer diameter smaller than an inner diameter of the ring gear 52.

At least one second gear tooth 58 among the plurality of second gear teeth 58 may be engaged with at least one first gear tooth 56 among the plurality of first gear teeth 56 so that power is transmitted in a forward direction from the driving unit 10 toward the output shaft 30.

The disk member 54 is geared to the first gear teeth 56 of the ring gear 52 inside the ring gear 52. When the second gear teeth 58 provided on the disk member 54 are geared to the first gear teeth 56, the disk member 54 is eccentrically positioned toward one side inside the ring gear 52.

As illustrated in FIGS. 8 to 12, since the disk member 54 is eccentrically positioned inside the ring gear 52, when the disk member 54 is geared to the ring gear 52, some of the first gear teeth 56 among the plurality of first gear teeth 56 and some of the second gear teeth 58 among the plurality of second gear teeth 58 may be engaged, but the remaining first gear teeth 56 and the remaining second gear teeth 58 may not be engaged.

In addition, the output shaft 30 in the present embodiment includes a plate member 34 on which the disk member 54 is movably seated, and the disk member 54 is movably connected to the plate member 34 by the eccentric connection unit 70.

Accordingly, as the disk member 54 revolves along the inner wall of the ring gear 52 and simultaneously rotates using the power input from the driving unit 10, interference may occur at a connection portion between the eccentrically connected disk member 54 and the concentrically connected plate member 34. However, since the disk member 54 is movably supported on the plate member 34 by the eccentric connection unit 70, interference between the revolving disk member 54 and the plate member 34 may be prevented.

As described above, even when the disk member 54 performs both revolution and rotation simultaneously, the revolution of the disk member 54 is constrained as the disk member 54 slides on the upper surface of the plate member 34, and the power input from the motor 12 may be transmitted to the output shaft 30 as the plate member 34 and the output shaft 30 are rotated by the rotation of the disk member 54.

The eccentric connection unit 70 in the present embodiment includes an eccentric block 72, to which the drive shaft 14 of the driving unit 10 is eccentrically connected and which is rotatably inserted into the disk member 54, and transmission shafts 76 extending from the plate member 34 to be inserted into a plurality of transmission holes 78 formed in the disk member 54.

A connection hole 74 is formed at a central portion of the disk member 54, into which the eccentric block 72 is inserted to allow idle rotation, and the transmission shafts 76 extending from the plate member 34 are respectively inserted into the plurality of transmission holes 78 formed at the edge of the disk member 54.

In addition, since the inner diameter of the transmission hole 78 in the present embodiment is formed larger than the outer diameter of the transmission shaft 76, the disk member 54 is slidably seated on the plate member 34, and the transmission shaft 76 is movably inserted into the transmission hole 78.

Accordingly, when the drive shaft 14 of the motor 12 connected to the eccentric block 72 rotates, the eccentric block 72 forms a rotation radius equal to the eccentric distance and provides eccentric power, and the rotational motion of the eccentric block 72 is transmitted to the disk member 54, causing the disk member 54 to revolve along the inner wall of the ring gear 52.

For example, since the second gear teeth 58 of the disk member 54 maintain a gear connection with the first gear teeth 56 of the ring gear 52, the disk member 54 revolving along the inner wall of the ring gear 52 simultaneously performs rotation due to the first gear teeth 56 and the second gear teeth 58. As a result, the power of the motor 12 is converted into eccentric power of the disk member 54 and decelerated, and the decelerated power is converted from the eccentric power of the disk member 54 into concentric power of the plate member 34 and the output shaft 30 and transmitted.

In the present embodiment, the clearance between the inner diameter of the transmission hole 78 and the outer diameter of the transmission shaft 76 is formed to be equal to the eccentricity of the eccentric block 72. When the eccentric block 72 rotates, the rotational force of the eccentric block 72 is transmitted to the disk member 54. For example, at least one second gear tooth 58 among the plurality of second gear teeth 58 is engaged with at least one first gear tooth 56 among the plurality of first gear teeth 56, so that the second gear teeth 58 of the disk member 54 are geared to the first gear teeth 56 of the ring gear 52. As a result, the first gear teeth 56 and the second gear teeth 58 interfere with each other, causing the disk member 54 to rotate in the direction opposite to the rotation direction of the eccentric block 72.

In the present embodiment, the case 90 has an open upper surface and is installed to be opened and closed by a cover member 92. A passage is provided in a bottom surface of the case 90, through which the output shaft 30 extends and is geared to a steering shaft 94.

As illustrated in FIGS. 8 and 9, when the drive shaft 14 (see FIG. 7) rotates and an eccentric portion 73 of the eccentric block 72 rotates 90° clockwise as shown in the drawing, a reference point A of the second gear teeth 58 illustrated in FIG. 8 rotates counterclockwise by a predetermined angle. As illustrated in FIG. 10, when the eccentric portion 73 further rotates approximately 100° clockwise, the reference point A of the second gear teeth 58 passes over a tip of the first gear teeth 56 and rotates counterclockwise by a predetermined angle. As illustrated in FIGS. 11 and 12, when the eccentric portion 73 rotates 360°, the reference point A of the second gear teeth 58 passes over a tip of the first gear teeth 56 and seats in an adjacent root.

As described above, when the eccentric block 72, rotated clockwise by the drive shaft 14 of the motor 12, completes a full 360° rotation, the disk member 54, rotated by the eccentric block 72, undergoes a deceleration operation as the second gear teeth 58 pass over a tip formed by the first gear teeth 56.

As described above, as power from the motor 12 is decelerated and transmitted through the drive shaft 14, the eccentric block 72, the disk member 54, and the output shaft 30, enabling the steering shaft 94, connected to a gear portion 32 of the output shaft 30 via a worm gear mechanism, to be driven, so that the decelerator in the present embodiment may be applied to a vehicle steering system or a rear wheel steering system.

In addition, the present embodiment further includes a support 80 that connects a plurality of transmission shafts 76, and the support 80 is formed with a prevention hole 82 that prevents interference between the drive shaft 14 and the support 80.

In the present embodiment, the transmission shafts 76 protrude upward from the plate member 34, and four transmission shafts 76 are disposed at regular intervals to allow the disk member 54 to be seated on the upper surface of the plate member 34 so that the transmission holes 78 receive the respective transmission shafts 76. The upper ends of the transmission shafts 76 exposed through the upper surface of the disk member 54 are connected to the support 80 having a rectangular band shape, and the prevention hole 82 is formed in a central portion of the support 80.

As described above, since the drive shaft 14 of the motor 12 passes through the prevention hole 82 and is installed on the eccentric block 72, interference between the drive shaft 14 of the motor 12 and the transmission shaft 76 may be prevented when the disk member 54 rotates.

When the decelerator in the present embodiment is installed in a rear wheel steering system, steering force transmitted from the drive wheels of the vehicle may move the steering shaft 94 to one side or the other side, so that power in the reverse direction may be input to the deceleration unit 50 through the output shaft 30.

Under this condition, since the disk member 54, positioned eccentrically with respect to the output shaft 30 and the drive shaft 14 by the eccentric block 72, interferes with the ring gear 52, the disk member 54 does not rotate in response to the rotational force of the output shaft 30. Accordingly, the decelerator of the present disclosure prevents power transmission from the output shaft 30 toward the drive shaft 14 of the driving unit 10, that is, in the reverse direction.

More specifically, when power is input to the output shaft 30 in the reverse direction, which is opposite to the forward direction from the driving unit 10 toward the output shaft 30, at least one second gear tooth 58 among the plurality of second gear teeth 58 is blocked by at least one first gear tooth 56 among the plurality of first gear teeth 56, thereby preventing the disk member 54 from rotating.

Referring to FIG. 8, for example, when counterclockwise rotational power is transmitted to the plate member 34 through the output shaft 30, only one transmission shaft 76, positioned at the 9 o'clock position among the four transmission shafts 76, presses the disk member 54 downward, and the remaining three transmission shafts 76 do not press the disk member 54.

Therefore, the disk member 54 is pressed downward, and some of the second gear teeth 58 that are not engaged with the first gear teeth 56 among the plurality of second gear teeth 58 are blocked by some of the first gear teeth 56 positioned opposite, thereby preventing movement. Accordingly, the disk member 54 does not revolve along the inner circumferential surface of the ring gear 52, and the transmission of rotational force in the reverse direction from the output shaft 30 toward the drive shaft 14 is blocked.

Accordingly, the decelerator may be configured to decelerate power input from the driving unit 10 and transmit the resulting power to the output shaft 30, block power input in the reverse direction through the output shaft 30 to enable application in a vehicle steering system, and incorporate a cycloidal gear with a simple structure, which realizes both deceleration and reverse input blocking functions, into the deceleration unit 50 to provide the reverse input blocking function without a separate blocking device.

Although the present disclosure has been described with reference to an embodiment illustrated in the drawings, the embodiment is merely illustrative, and those skilled in the art will appreciate that various modifications and other equivalent embodiment can be made from the embodiment disclosed herein.

In addition, although the decelerator has been described as an example, this is merely illustrative, and the device of the present disclosure may also be used in products other than decelerators.

Therefore, the true technical scope of the present disclosure should be defined by the claims below.

What is claimed is:

1. A decelerator comprising:
a driving unit configured to provide a power output to a drive shaft;
a deceleration unit configured to receive and decelerate the power output from the drive shaft of the driving unit and to transmit a resulting decelerated power;
an output shaft concentrically connected to the deceleration unit and configured to output the decelerated power transmitted from the deceleration unit; and
an eccentric connection unit configured to eccentrically connect the drive shaft of the driving unit and the deceleration unit to cause deceleration using eccentric power and to block power input in a reverse direction through the output shaft.

2. The decelerator as claimed in claim 1, wherein the deceleration unit includes:
a ring gear having a plurality of first gear teeth on an inner wall; and
a disk member disposed inside the ring gear, having an outer diameter smaller than an inner diameter of the ring gear, and having a plurality of second gear teeth,
wherein at least one second gear tooth among the plurality of second gear teeth is engaged with at least one first gear tooth among the plurality of first gear teeth to allow the power output of the driving unit to be transmitted in a forward direction to the output shaft.

3. The decelerator as claimed in claim 2, wherein the output shaft includes a plate member on which the disk member is movably seated, and the disk member is movably connected to the plate member by the eccentric connection unit.

4. The decelerator as claimed in claim 3, wherein the eccentric connection unit includes:
an eccentric block eccentrically connected to the drive shaft of the driving unit and rotatably inserted into the disk member; and
a transmission shaft extending from the plate member to be inserted into a plurality of transmission holes formed in the disk member.

5. The decelerator as claimed in claim 4, wherein an inner diameter of the transmission hole is formed larger than an outer diameter of the transmission shaft, and the disk member is slidably seated on the plate member.

6. The decelerator as claimed in claim 5, wherein a clearance between the inner diameter of the transmission hole and the outer diameter of the transmission shaft is formed to be equal to eccentricity of the eccentric block.

7. The decelerator as claimed in claim 4, further comprising a plurality of transmission shafts and a support configured to connect the plurality of transmission shafts to one .

8. The decelerator as claimed in claim 7, wherein the support includes a prevention hole configured to prevent interference between the drive shaft and the support.

9. The decelerator as claimed in claim 2, wherein, in response to power input in the reverse direction to the output shaft, at least one second gear tooth among the plurality of second gear teeth is blocked by at least one first gear tooth among the plurality of first gear teeth so that the disk member does not rotate.

10. The decelerator as claimed in claim 1, wherein the decelerator is installed in a vehicle rear wheel steering system.
